(19) United States
(12) Patent Application Publication
(10) Pub. No.: US 2012/0196027 A1
(43) Pub. Date: Aug. 2, 2012

(54) MICROWAVEABLE WHOLE OAT FLAKES

(76) Inventors: James D. Hansa, Algonquin, IL (US); Jerome D. Kessler, Crystal Lake, IL (US); Joseph Griebat, Mechanicsville, IA (US)

(21) Appl. No.: 13/256,117

(22) PCT Filed: Dec. 18, 2009
(86) PCT No.: PCT/US09/68795

§ 371 Date: Apr. 16, 2012

Related U.S. Application Data
(60) Provisional application No. 61/140,346, filed on Dec. 23, 2008.

(51) Int. Cl. A23L 1/164

(52) U.S. Cl. 426/627; 426/455

(57) ABSTRACT

A whole oat flake product with hydration rate sufficient to allow quick microwave cooking essentially without boil-up or foam-over.

### FIELD OF THE INVENTION

The invention relates to microwaveable whole oat flakes. In particular, the invention relates to uncut oat flake product with hydration rate sufficient to allow quick microwave cooking essentially without boil-up or foam-over.

### BACKGROUND OF THE INVENTION

Natural cereals, such as hot oat cereals, are well accepted by consumers. With respect to oats, this may be due, in part, to the widespread publication of the beneficial impact of oat bran in providing a healthful lowering of low density lipoprotein cholesterol components in the human system.

The oat is a highly nutritious grain, not only in terms of possessing outstanding soluble fiber levels, but also in terms of the richness of its protein, mineral, and lipid content, as well as other nutritive components.

In view of the increased appreciation of the healthful, beneficial effects of oat products, it is desirable to improve the efficiency and results of traditional oat groat processing, without adversely affecting the natural wholesomeness of the product.

Also, the widespread utilization of these benefits would be enhanced by improvements in the convenience of consumer preparation, and by improvements in the quality of the consumer prepared product.

In addition, the increasingly stringent consumer standards for high quality products, in terms of both organoleptic and convenience attributes, and in terms of healthful nutritional impact, must be met in the products of very economical processes in order for the cereal product to survive in the current, highly competitive marketplace. Moreover, such products, when packaged in conventional packaging materials, must be shelf stable, to the extent of remaining in a desirably consumable form, and in a form which is readily prepared by the consumer, during the time after manufacture, through the distribution and marketing systems, prior to the consumption by the consumer.

In addition to the organoleptic properties and characteristics of, for example, aroma, flavor, and texture. Other factors, such as convenience of preparation, are important in the success of competitive hot cereal products. For example, there is a variety of flake thicknesses made to meet consumer preferences and demands, such as for example “Steam Table,” “Old Fashioned,” “Quick,” and “Instant” types. Differentiating characteristics of these types of products include not only flake thickness but also convenience of consumer preparation, as reflected in preparation time and attention required.

Because microwave ovens have become ubiquitous, preparation of hot oat cereals in a microwave oven, whether commercially, for example in a restaurant, or at home by a consumer, also has become increasingly popular. Parents are believed to be increasingly likely to encourage their pre-teen and adolescent family members to prepare a personal serving bowl of hot oat cereal in the microwave.

However, one of the characteristics of certain of the types of heretofore available flaked oat cereals is the tendency to foam out of the bowl in ordinary microwave preparation, unless considerable care and precision in measuring, timing, and the like are exercised, or a larger-than-necessary container is used. Of course, many youthful consumers, and others, are not noted for assiduously following such preparation instructions.

Microwave foam-over is a substantial problem during the cooking of raw oat products, using the amount of oats and the amount of water generally believed to be appropriate for the amount of oats. Foam-over, or boil-up, is the tendency of the oat-containing food to expand to a volume significantly greater than the volume of the oats and water, and is wasteful and inconvenient. For example, foam-over typically requires that a larger container than is necessary to hold either the oats and water or the cooked product thereof. If the product does foam over, the oven must be cleaned. Further, the cooking container always must be cleaned.

Hence, it would be desirable to provide improvements in oat processing which result in an oat cereal product which is not particularly sensitive to reproduction of exact conditions such as timing and the quantity of water, for successful and convenient preparation in a microwave oven.

### BRIEF SUMMARY OF THE INVENTION

A first embodiment is directed to an uncut oat flake product with hydration rate sufficient to allow quick microwave cooking.

A second embodiment is directed to an uncut oat flake product with hydration rate sufficient to allow quick microwave cooking essentially without boil-up or foam-over.

A third embodiment is directed to an uncut oat flake product with a thickness between about 0.014 and about 0.022 inches.

A fourth embodiment is directed to an uncut oat flake product with a thickness between about 0.018 and about 0.022 inches and a hydration rate sufficient to allow quick microwave cooking essentially without boil-up or foam-over.

### DETAILED DESCRIPTION OF THE INVENTION

An embodiment of the invention is directed to an uncut oat flake product that has a hydration rate sufficient to allow for quick microwave cooking. In particular, an embodiment of the invention is directed to such an uncut oat flake product that allows for quick microwave cooking essentially without boil-up or foam-over. Quick preparation in a microwave oven will make it easier for parents to encourage their children to eat oat products as the child will not have long to wait for the product. Essentially no boil-up or foam-over means that the product can easily and conveniently be prepared in a bowl sufficient in volume to hold the oats and water or the product without requiring significant additional volume to accommodate boil-up. Therefore, the product can be conveniently prepared in a short period and prepared and consumed from the same bowl.

In accordance with an embodiment of the invention, the inventors have discovered that whole oat groats, when formed into flakes within a particular range of thicknesses yields uncut whole oat flakes that have a cooking time of about 1 minute under microwave oven cooking conditions for a typical single serving. Thus, the whole oat flake-containing product is quickly prepared in the microwave oven.

The skilled practitioner recognizes that whole oat groats are whole hulled oat grains that have been processed before flaking. Oat groats are the kernel product resulting from the cleaning and drying of oats, which removes the hulls. The processed oats useful in the present invention are prepared from whole oat groats. The whole oat groats are steamed to deactivate enzymes and then processed in a kiln, or dryer, to develop flavor and to at least partially cook starch in the groat. The groat then is steamed again to condition the groat in preparation for flaking. The flakes then are dried to the desired moisture content. The conditions under which these processes typically are carried out are known to a skilled practitioner.

After steaming, the groats are subjected to high temperature treatment in, for example, a kiln or a dryer, until the whole oat groats have reached a temperature of from about 225° to about 315° F., typically from about 240° F. to about 285° F., and more typically from about 250° F. to about 275° F., and a moisture content of from about 2 to about 8 percent. This treatment is used to develop flavor and can occur in any commercially available hot air oven or dryer or other suitable available apparatus. This drying step, also called toasting, typically requires a period of about 4 minutes to about 120 minutes, preferably from about 15 to about 25 minutes. During this treatment, the whole oat groats are continually agitated in order to prevent overheating of any particular portion of the oat groats. After the heating treatment is completed, the oat groats must be cooled rapidly to below 150° F. in order to stop the toasting operation and prevent overtoasting.

The cooled groats then are steamed prior to being flaked. The steaming process is a means of reducing the amount of fines and breakages in the flaked product. The oats are heated utilizing steam at a temperature of from about 190° to about 210° F., preferably about 205° F. for a period of from about 2 minutes to about 5 minutes, preferably about 3 minutes. The oats then have a moisture content of from about 13 to about 16 percent, preferably about 15 percent.

The hot, steamed oats then are fed to the conventional flaking rolls and equipment. With the guidance provided herein, the skilled practitioner will be able to prepare whole oat groats in an appropriate manner.

Thus-prepared hulled oat grains then are flaked by any known method to yield a thickness between about 0.014 and about 0.022 inches. The prepared groats may be steel-cut, rolled, or flaked in any manner known to the skilled practitioner that will yield the desired thickness. The groats are not cut, and therefore yield whole oat flakes that have the advantage of being a healthful, whole-grain product.

Although the inventors do not wish to be bound by theory, it is believed that the rapid hydration resulting from the high hydration rate of the flakes affords the opportunity for the flakes to quickly adsorb the water used to cook the flakes. It is believed that additional channels for water flow may be opened in embodiments of the invention. Because the water is absorbed into the flake, there is essentially no boil-up or foam-over. Further, it is believed that flakes that are highly hydrated are cooked more quickly under microwave conditions than are non-hydrated flakes in view of the way microwaves agitate water molecules to heat an object.

In embodiments of the invention, the starch chains are different from those in the whole oat groat before flaking. Although the inventors do not wish to be bound by theory, it is believed that these changes in the starch chains may reduce cooking time.

The skilled practitioner recognizes that microwave ovens differ in power delivered to the product being heated. The about 1 minute cooking time relates to an average or typical consumer microwave oven, i.e., an oven that operates at 1000 watts. A more powerful oven likely will cook the product in less time, but the time is not likely to be inversely proportional to the power applied. Although the inventors do not wish to be bound by theory, it is likely that there exists some minimum period required to fully hydrate the whole oat flakes. As the skilled practitioner recognizes, it is likely that a consumer will consider an incompletely hydrated product to be not fully cooked. Therefore, there exists a minimum cooking time of the period required to at least fully hydrate the oat flakes. With the guidance provided herein, the skilled practitioner will be able to determine the exact cooking time of product of embodiments of the invention in any selected microwave oven.

In another embodiment of the invention, the oat flake product is quickly prepared under microwave oven conditions without boil-up or foam-over. Boil-up is the phenomenon wherein the materials being heated, oat flakes and water, expand to several times the original volume when subjected to microwaves. The volume is reduced essentially instantly upon cessation of the microwave exposure.

Avoidance of boil-up is important for convenience of preparation and clean-up, and in ease of use. Preparation is simplified over preparation of a product that boils-up because only the container from which the product is to be consumed need be used to prepare the product. In this way, no dangerous transfer of hot food from a preparation container to a consumption container is necessary. Also, it is necessary only to clean one container, and it will not be necessary to clean up a messy oven, when boil-up is essentially avoided.

In accordance with another embodiment of the invention, the treated whole oat groats are flaked to a thickness of between about 0.014 and about 0.022 inches, typically between about 0.018 and about 0.022 inches, more typically between about 0.019 and about 0.021 inches, and most typically about 0.020 inches. The inventors have discovered that flakes of this dimension quickly imbibe water and become hydrated under microwave conditions, thus cooking quickly and essentially free of boil-up.

The skilled practitioner recognizes that typical commercial flaking processes will result in some small percentage, perhaps about 5 to about 10 percent, of flakes that are thinner and some that are thicker than the endpoints of the range. So long as the percentage of flakes outside the range remains a small percentage of the total, any potential adverse effect will be minimized.

Because whole oat groats are flaked, the dimensions of the oat flakes typically vary as the sizes of oat groats varies at the point at which the flake is formed. For the purposes of this invention, the thickness is maintained within the ranges disclosed herein and the remaining dimensions are not strictly controlled. Whereas a high concentration of fines may present a mushy or pasty texture upon rehydration, oat flakes having the thickness of flakes of embodiments of this invention are not likely to degrade to form a significant fraction of fines unless they are handled very roughly.

The essential elimination of boil-up in embodiments of the invention is an advantage that makes it possible for the consumer to prepare the product in a container large enough to accommodate the raw ingredients or the product, which typically are about the same volume. In accordance with these embodiments, there is no need to use a large container to accommodate boil-up.

This advantage can be realized by the consumer in a number of ways. The product can be prepared in the container from which it will be consumed, such as a cereal bowl. Because boil-up has been essentially eliminated, there is no need to use a larger container for preparation. Indeed, there is no need to use a separate container for preparation, thus reducing the number of containers that need to be cleaned.

Further, healthy, whole-oat-containing foods, and in particular, oatmeal, can easily and safely be prepared from products of embodiments of this invention. Thus, children can prepare their own meals with less chance for mishaps during cooking and the now-eliminated transfer from cooking container to tableware, such as to cereal bowls. Thus, children can not only become self-sufficient, but also take some pride in the accomplishment of preparing one's own meal.

The texture of product obtained in accordance with embodiments of the invention is favored by consumers. As the hydration and cooking of the oat flakes is done quickly, there exists less opportunity to degrade the texture toward mushiness. Thus, the product is not mealy, mushy, pasty, or slimy. Of course, it is possible to adjust the quantity of water to prepare and thinner or thicker oatmeal in embodiments of the invention. These minor adjustments provide the consumer with a customizable product that is well-received for its pleasing texture and mouthfeel and flavor judged to be of superior quality.

The resultant product is a tasty whole grain product appreciated by consumers for both its organoleptic properties and characteristics and its quick and easy method for preparation. The product also is healthy and nutritious, as it is a whole grain product.

Whereas embodiments of the invention described hereinabove related only to oats, products comprising products made in accordance with embodiments of the invention also can be mixed with various flavors and colors. Flavoring is an organoleptic property and characteristic that likely will appeal to consumers of all ages. Coloring might appeal more to children, but adults can appreciate a colorful product as well.

The skilled practitioner is familiar with flavor systems suitable for use in, for example, oatmeal breakfast cereal. Examples of suitable flavors include fruits, including in particular apple and peach; spices, including cinnamon and nutmeg; and other flavors, such as brown sugar, maple, and nuts, including walnuts and pecans. Flavor systems also can include pieces of fruit, typically as freeze-dried pieces that are re-hydrated when the oat flakes are hydrated.

Miscellaneous materials, such as sugar, salts (sodium chloride, potassium chloride, and others), other flavoring agents, vitamins and minerals, oils, butylated hydroxytoluene and other preservatives, packaging agents such as anti-clumping agents, and other materials also can be present in minor amounts. The skilled practitioner will be able to identify other constituents that are well-known in cereal formulations and well-known as compatible with oat cereal in general and product of the invention in particular, and will be able to determine the correct quantity for use with the embodiments of the invention.

Other grains may be present with the oatmeal, typically in small quantities. Corn grit, wheat flake, and other grains can be included with the oat flakes. Adding such other grains or other products may change the texture and flavor of the combination and may add nutrients not found in oats.

The following example is meant to exemplify the invention, not to limit it in any way. The invention is limited only by the appended claims.

### EXAMPLE 1

Product that is uncut oat flakes having a thickness between about 0.014 inches and 0.022 inches and a hydration rate sufficient to allow quick microwave cooking essentially without boil-up or foam-over in accordance with the invention was prepared in a microwave oven without boil-over.

### EXAMPLE 2

The product of Example 1 was taste-tested. The testers were instructed to rate the prepared product on two scales of organoleptic properties and characteristics, “Nutty/Brown Sugar/Rough” and “Powdery to Thick/Slick/Gummy.” Tasters also evaluated other oatmeal products prepared in a microwave oven. These products were “old-fashioned” type oatmeal and “thick quick” type oatmeal.

All products were compared to a ‘target’ flavor. The target flavor of oatmeal that best satisfies tasters, is an oatmeal flavor that is relatively high on the “Thick/Slick/Gummy” scale and mid-range on the “Nutty/Brown Sugar/Rough” scale. The scales range from 0 to 100 on the “Nutty/Brown Sugar/Rough” scale and from 0 (Powdery) to 100 (Thick/Slick/Gummy) on the “Thick/Slick/Gummy” scale.

The following table summarizes the positions of the three products and the position of the target product on these scales.

| Product | Nutty/Brown/Rough | Thick/Slick/Gummy |
|---|---|---|
| Target | 53 | 72 |
| Product of the invention | 51 | 68 |
| Old-fashioned | 64 | 73 |
| Thick Quick | 68 | 65 |

As can be seen from this table, the product of the invention most closely duplicated the target organoleptic properties and characteristics. Thus, not only did the oatmeal not boil-up during preparation, but also the resultant oatmeal product was closest to the target organoleptic properties and characteristics.

While the invention has been described with respect to specific embodiments, including preferred modes of carrying out the invention, those skilled in the art will appreciate that there are numerous variations and permutations of the above described systems and techniques that fall within the spirit and scope of the invention as set forth in the appended claims. For example, there may be treatment conditions different from those set forth herein but are suitable for preparing the groats.

1. A microwaveable whole oat flake that can be cooked within about 1 minute under microwave conditions in a microwave oven essentially without boil-up.

2. The whole oat flake of claim 1 having a thickness of between about 0.014 and about 0.022 inches.

3. The whole oat flake of claim 2 having a thickness of between about 0.018 and about 0.022 inches.

4. The whole oat flake of claim 3 having a thickness of between about 0.019 and about 0.021 inches.

5. The whole oat flake of claim 4 having a thickness of about 0.020 inch.

6. A microwaveable whole oat flake that has a rehydration rate sufficient to rehydrate the flake and cook it within 1 minute essentially without boil-up under microwave conditions in a microwave oven.

7. The whole oat flake of claim 6 having a thickness of between about 0.014 and about 0.022 inches.

8. The whole oat flake of claim 7 having a thickness of between about 0.018 and about 0.022 inches.

9. The whole oat flake of claim 8 having a thickness of between about 0.019 and about 0.021 inches.

10. The whole oat flake of claim 9 having a thickness of about 0.020 inch.

11. A microwaveable whole oat product that has a rehydration rate sufficient to rehydrate the flake and cook it within 1 minute essentially without boil-up under microwave conditions in a microwave oven.

12. The whole oat product of claim 11 consisting essentially of whole oat flakes having a thickness of between about 0.014 and about 0.022 inches.

13. The whole oat product of claim 12, wherein the flakes have a thickness of between about 0.018 and about 0.022 inches.

14. The whole oat product of claim 13, wherein the flake having a thickness of between about 0.019 and about 0.021 inches.

15. The whole oat product of claim 14, wherein the flake having a thickness of about 0.020 inch.

16. The whole oat product of claim 5 wherein the rehydration rate is sufficient to essentially preclude boilover under microwave conditions in a microwave oven.

17. A method of making a microwavable whole oat flake that can be fully cooked without boil-up in one minute in a microwave oven, said method comprising:
toasting steamed whole oat groats until the moisture content of the groat is between about 2 and about 8 weight percent and the temperature is between 225° F. and about 315° F.,
quickly cooling the toasted groats to 150° F.,
steaming the cooled groats until the temperature is between about 190° F.-about 210° F., and
flaking the steamed groats to a thickness between about 0.14 and about 0.22 inches.

18. The method of claim 17, wherein the flakes have a thickness of between about 0.018 and about 0.022 inches.

19. The method of claim 18, wherein the flake having a thickness of between about 0.019 and about 0.021 inches.

20. The method of claim 19, wherein the flake having a thickness of about 0.020 inch.
